(19) United States
(12) Patent Application Publication
(10) Pub. No.: US 2026/0179484 A1
(43) Pub. Date: Jun. 25, 2026

(54) SYSTEM AND METHOD FOR AUTONOMOUS VEHICLE ALERTING

(71) Applicant: Emergency Safety Solutions, Inc., Houston, TX (US)

(72) Inventors: Stephen T. Powers, Houston, TX (US); Timothy R. VanGoethem, Milford, MI (US)

(21) Appl. No.: 19/413,090

(22) Filed: Dec. 9, 2025

Related U.S. Application Data
(60) Provisional application No. 63/729,784, filed on Dec. 9, 2024.

(51) Int. Cl. G08G 1/0967; B60W 50/00; B60W 60/00

(52) U.S. Cl. CPC G08G 1/096725; B60W 50/0097; B60W 60/0027; B60W 2554/20; B60W 2554/4042; B60W 2554/4044; B60W 2556/45; B60W 2556/50

(57) ABSTRACT

A microprocessor in a vehicle is communicatively coupled to an autonomous driving system having at least some operational control over the vehicle. A radio is receiver communicatively coupled to the microprocessor that receives an indication from a remote server that a condition exists at a roadway location predicted to be encountered by the vehicle within a predetermined timeframe. The microprocessor communicates the indication and its location to the autonomous driving system.

### CROSS-REFERENCE TO RELATED CASES

This application claims the benefit of U.S. provisional patent application Ser. No. 63/729,784, filed on Dec. 9, 2024, and incorporates such provisional application by reference into this disclosure as if fully set out at this point.

### FIELD OF THE INVENTION

This disclosure relates to electronic vehicle alerting in general and, more specifically, to a system and method for providing digital vehicle alerts to a vehicle with autonomous driving features.

### BACKGROUND OF THE INVENTION

With respect to autonomous operation, vehicles may have capabilities ranging from no automation, so-called Level 0, up to full automation, or Level 5. A Level 5 vehicle may operate entirely without human intervention in every condition in which the vehicle can operate. Commonly vehicles will fall in between these two extremes and provide radar cruise control, intelligent cruise control, steering assist, automatic braking, and perhaps other convenience or safety features.

Beyond basic cruise control based only on vehicle speed, a vehicle has a need to gather input via sensors to enable decision making and control based on road conditions, traffic, and other factors. Vehicle sensors are currently limited to line-of-sight inputs. If a roadway hazard or other condition is out of sight (e.g., around a bend in the road, shrouded by fog or, otherwise hidden from view) it cannot be detected using current on-board sensors.

Even where a vehicle is detected by an on-board sensor of another vehicle, it may not be immediately clear to the detecting vehicle whether the detected vehicle is merely present on the roadway, travelling slower or faster than the detecting vehicle, or in a state of breakdown or other emergency.

What is needed is a system and method addressing these and related problems.

### SUMMARY OF THE INVENTION

The invention of the present disclosure, in one aspect thereof, comprises a system including a microprocessor in a vehicle communicatively coupled to an autonomous driving system having at least some operational control over the vehicle, and a radio receiver communicatively coupled to the microprocessor that receives an indication from a remote server that a condition exists at a roadway location predicted to be encountered by the vehicle within a predetermined timeframe. The microprocessor communicates the indication and its location to the autonomous driving system.

The system may further comprise a global positioning system providing vehicle location and heading to the remote server for predicting whether the vehicle will be at the roadway location within the predetermined timeframe. In some embodiments, the microprocessor predicts whether the vehicle will be at the roadway location within the predetermined timeframe.

The condition may comprise a stopped vehicle, a disabled vehicle, and/or a vehicle deploying high conspicuity lighting.

In various embodiments, at least some operational control comprises less than full (level 5) control. At least some operational control comprises between level 0 and level 5 control.

The microprocessor may report an event related to the vehicle along with at least vehicle location to the remote server via a radio transmitter. The event related to the vehicle may comprise the vehicle being disabled or stopped on or within a predetermined distance of a roadway.

The invention of the present disclosure, in another aspect thereof, comprises a system including a remote server in communication with a plurality of vehicles utilizing wireless communication. Each of the plurality of vehicles has an on-board microprocessor communicatively coupled to an autonomous driving system having at least some operational control over the respective vehicle. Each of the plurality of vehicles provides location and heading information pertaining to the respective vehicle to the remote server. The remote server receives an indication that a condition exists at a roadway location. The remote server determines which of the microprocessors of the plurality of vehicles to communicate the condition to for communication to the respective autonomous driving system based in part on the location and heading information received from each of the plurality of vehicles.

In some embodiments, the remote server receives the indication that the condition exists at the roadway location from one of the plurality of vehicles. In some cases the condition is a non-moving vehicle on or near a roadway. Each of the plurality of vehicles may provide at least a global position system (GPS) location, a heading, and a speed to the remote server. In some cases, the remote server determines which of the microprocessors of the plurality of vehicles to communicate the condition to by predicting which of the plurality of vehicles will be at the roadway location within the predetermined timeframe. The remote server may utilize mapping data to predict which of the plurality of vehicles will be at the roadway location within the predetermined timeframe by travelling on known roadways.

The invention of the present disclosure, in another aspect thereof, comprises a system including a remote server that receives a notification of a safety event and a location associated therewith, a plurality of microprocessors each one in communication with an autonomous driving system of a vehicle and with a global positioning system (GPS) associated with the vehicle, and a data link between the remote server and the plurality of microprocessors. Each of the microprocessors provides location information of the respective vehicle to the remote server via the data link. The remote server provides an alert of the safety event and the location associated therewith to at least a subset of the plurality of microprocessors. The subset of microprocessors each provides the alert and the location associated therewith to an input of the respective autonomous driving system.

In some cases, the subset of the plurality of vehicles comprise vehicles predicted by the remote server to be able to encounter the location associated with the safety event within a timeframe. The subset of the plurality of vehicles may comprise vehicles predicted by the remote server to be able to encounter the location associated with the safety event within a timeframe using known roadways.

In some embodiments, the safety event is a stoppage on or near a roadway of one of the plurality of vehicles, and the safety event is communicated by the one of the plurality of vehicles to the remote server via the data link.

### BRIEF DESCRIPTION OF THE DRAWINGS

FIG. 1 is a simplified schematic diagram of an alerting system according to aspects of the present disclosure.

FIG. 2 is a system level diagram showing communication links within an alert system according to aspects of the present disclosure.

FIG. 3 is a roadway diagram showing various scenarios for operation of the systems of the present disclosure.

FIG. 4 is an example of a hazard alert data format that may be used by systems of the present disclosure.

### DETAILED DESCRIPTION OF THE PREFERRED EMBODIMENTS

According to various embodiments of the present disclosure, a vehicle having self-driving capabilities (as now known to the art or developed in the future) may receive electronic alerts from outside the vehicle. The electronic alerts may include disabled vehicle alerts, indicating the presence of a disabled vehicle on or near a roadway. Electronic alerts may also include alerts relating to the presence or approach of an emergency vehicle. Emergency vehicles may include, without limitation, fire trucks, EMS, police, and wreckers. Electronic alerts can also be provided based on the presence of a slow moving or stopped vehicle on a road way, such as a delivery vehicle, heavy truck, construction equipment, etc.

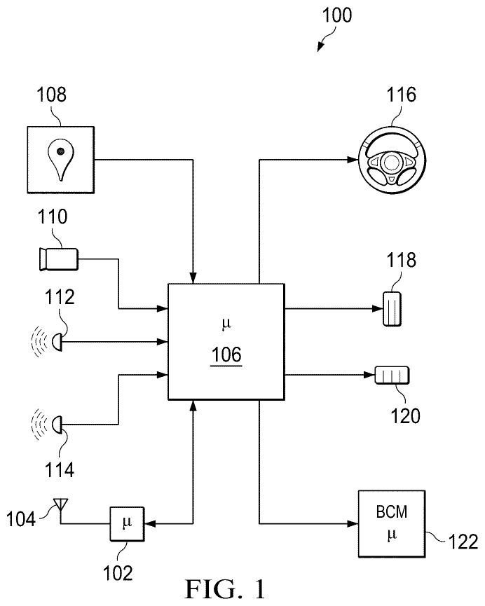

Systems of the present disclosure are susceptible to many embodiments. Reference to FIG. 1 shows an alerting system according to aspects of the present disclosure as implemented within a vehicle. A vehicle equipped as shown in FIG. 1 is capable of sending or receiving alerts as described herein.

An autonomous driving system 100 interacts with an alerting system transceiver 102 that receives alerts wirelessly via antenna 104. The alerts are passed electronically to an autonomous driving controller 106 (which may be any autonomous driving controller, system, or computer as known in the art) and are used as additional inputs to the controller to augment or supplement sensor data. Sensor data may include, without limitation, data from a camera 110, a lidar sensor 112, and/or a radar sensor 114. The controller 106 may receive other data or sensor information as is known to the art. For example, a GPS device 108 may provide real-time location data to the controller 106.

The alerting system transceiver 102 may have an integrated GPS device, or may rely on a GPS device already utilized by or present in the system 100 (such as GPS device 108).

The alerting system transceiver 102 may be in two-way communication with an alert server (e.g., remote server 201, discussed below) allowing alerts received by the alert system transceiver 102 and provided to the controller 106 to be relevant (based on location, speed, direction, and other factors) to the operating vehicle.

The alerting system transceiver 102 may be implemented by means known to the art to accomplish the specific tasks delineated herein. In some embodiments, the alerting system transceiver 102 is based on a microprocessor, microcontroller, or system-on-a-chip device. Programming or hard coding of the device may be based on any suitable method or language known to the art. Memory chips, amplifiers, signal conditioners, specific communication chips and other necessities known to the art may be employed as needed.

In some embodiments, the alerting system transceiver 102 may be an application or combination of application and hardware running on a mobile device such as a phone or tablet. The alerting system transceiver 102 may communicate with the controller 106 via a wired connection or with a wireless protocol where the alerting system transceiver 102 is not hard wired with the controller 106.

In some embodiments, the alerting system transceiver 102 may be implemented by additional programming of the controller 106 or other silicon device operating the relevant functions of an autonomous driving system. The alerting system transceiver 102 may be provided as original (OEM) equipment or may be added to a vehicle following manufacture by addition of appropriate hardware and/or programming. In some cases, some or all of the functionality of the alerting system transceiver 102 may be provided to the vehicle via software updates (over the air or otherwise).

As known in the art, the controller 106 may control some or all vehicle driving inputs. For example, the controller 106 may provide input to a steering system 116, an accelerator 118, a braking system 120, and to other control systems such as a body control module 122. It should also be understood that inputs to steering, accelerating, braking, etc. are not typically mechanical connections but electronic connections to the associated vehicle control system or module. The system 100 as illustrated in FIG. 1 is exemplary only and is not intended to be an exhaustive diagram of all interactions and communications of an autonomous driving system. Moreover, it should be understood that features and functions shown in FIG. 1 may be physically combined in execution. For example, the digital alerting system 102 may be integrated with the autonomous driving controller 106 by addition of circuitry or by updating programming of the controller 106 to perform the functions described herein.

It should also be understood that systems according to the present disclosure are not limited to interfacing with vehicles providing a high degree of driving autonomy (e.g., level 4 or 5) but can also be useful as input to simpler driving assist features such as automatic emergency braking or adaptive cruise control. Furthermore, the vehicle receiving the alert is not necessarily limited to a passenger car. The receiving vehicle may be, without limitation, a commercial truck, an emergency vehicle, a bus, or construction vehicle. The receiving vehicle may be any transportation device operating on or off road that provides any level of autonomous driving or operation features.

Alerts may be delivered via cell data network, satellite, or radio network as known to the art. For example, alerting systems that may be useful with various embodiments of the present disclosure are discussed in U.S. Pat. No. 12,109,938 to Tucker et al., titled SYSTEM FOR COMMUNICATION OF HAZARDOUS VEHICLE AND ROAD CONDITIONS, and in US Patent Application Publication No. 2024/0067087 by Tucker et al., titled VEHICLE DIGITAL ALERTING SYSTEM.

Any electronic alert affecting the real time operation or routing of a vehicle with self-driving or autonomous driving features may be included in the data available to the autonomous driving system 102. Currently visual data, radar, lidar, and sonic information may be used along with map data to inform the autonomous driving system as to the real time decisions to be made such as acceleration or braking, steering etc. By providing electronic alerts for known obstacles, hazards, or unusual conditions on the roadway, an additional and valuable input is provided to the autonomous driving system.

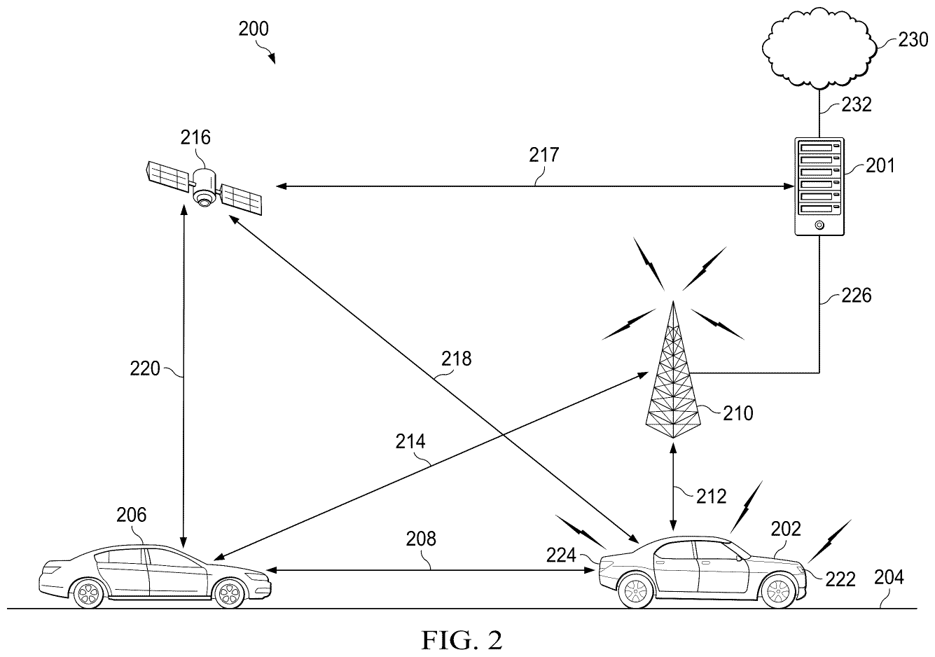

Referring now to FIG. 2, a system level diagram showing communication links within an alert system 200 according to aspects of the present disclosure is shown. Here, a vehicle 202 is shown a distance apart on a roadway 204 from a second vehicle 206. It should be understood that the vehicles may be much further away than shown and that terrain, obstacles, and other cars may interpose the two exemplary vehicles shown. At least one of the vehicles 202, 206, and possibly both, are equipped as autonomous vehicles capable of at some degree of self-driving. For purposes of illustration, vehicle 206 must be so equipped as well as having an autonomous vehicle alerting system (e.g., 102) in communication with the autonomous of self-driving system of the vehicle 206 itself.

In the present example, vehicle 202 has encountered a hazard, breakdown, collision, or other event that has caused the vehicle 202 to be placed in a state of hazard, emergency, or distress. A high conspicuity visual indicator may be deployed by the vehicle 202. In this case the high conspicuity visual indicator comprises front signal lights 222 and rear signal lights 224, and both may be strobing at a high rate, and/or providing a directional strobe (e.g., right to left). This may occur manually by action of the driver or another occupant, or automatically by one or more automatic vehicle systems. In order to provide advance warning to other drivers, or to summon emergency services, or for other reasons, the hazard state may be communicated wirelessly.

A communication link may exist between the vehicle 202 and a remote server 201. The server 201 is a remote server in that it is not present on either of the vehicles 202, 206 nor even necessarily geographically limited by the locations of the vehicles 202, 206 or the roadway 204. The communication link may comprise a wireless phone or data network (e.g., cellular) represented here by network tower 210 as shown by cellular communication link 212. The network tower 210 may comprise a phone and data network such as a 3G/4G/5G or other network. While one tower 210 is shown for illustration, multiple towers may be present to cover or overlap different roadways or geographic areas. Systems and methods of the present disclosure are intended for operation with any known network unless otherwise indicated. The communication link between the remote server 201 and the vehicles 202, 204 may also comprise wireline connection or communication links 224 between the server 201 and tower 210 (and/or other towers) as known to the art.

In the example shown, the vehicle 202 communicates the hazard condition to vehicle 206 thus allowing the autonomous driving system associated with or operating vehicle 206 take appropriate action even before vehicle 202 becomes detectable to any of vehicle 206's sensors. In some embodiments, radio communication 208 may occur directly, vehicle-to-vehicle. The signal or alert communicated in this direct fashion could be a digital or analog signal occurring on a dedicated radio frequency set aside for such purpose. However, it may also occur via a network system having a built-out infrastructure such as, but not limited to, a mobile phone network or a satellite-based network.

It should be understood that more than one car may receive the alert or indication of the emergency from vehicle 202. For example, more than one vehicle may receive a locally broadcast signal. Additionally, in some embodiments, the vehicle 206 may automatically further relay the received information in a daisy-chain like fashion. In some embodiments, there may be a limit to the number of times or the distance that the emergency indication or hazard may be relayed. For example, there may be little or no benefit to relaying a message to a vehicle several away that may not encounter the hazard at all, or not within any reasonable time frame. The distance a receiving vehicle is from an originally transmitting vehicle may be based on available GPS data, cell tower data, or other information available to the microprocessor 102.

It is contemplated that the direct, wireless, vehicle-to-vehicle communication by systems of the present disclosure may take place by any known wireless radiofrequency protocol. It should also be understood that vehicle-to-vehicle communication may take place via visual light signaling (e.g., vehicle 206 monitoring for high frequency strobing of lights on vehicle 202, such as by camera 120), via infrared (with IR transceivers integrated with the associated vehicles) or via other light-based communication methods.

The network 210 may communicate the emergency or hazard to other vehicles in the area as shown by cellular communication link 214. Here again, not every vehicle in the area is necessarily impacted by the particular hazard being encountered by vehicle 202.

The systems on-board the alerted vehicles (e.g., system 100) may discriminate between hazards affecting or not affecting the alerted vehicle based on location and type of emergency (if provided). For example, a hazard on an adjacent street would not necessarily cause an alarm or any other action on a vehicle receiving indication of the hazard from network 210. In further embodiments, the server 230 tracks multiple vehicle locations and headings. This information may be combined with mapping data to allow the server 230 to predict which vehicles are likely to encounter the vehicle 202 or other hazard within a predetermined timeframe or distance (e.g., by roadway travel) and alert only those vehicles for which the vehicle 202 or other hazard is relevant.

In another embodiment, the presence of the hazard may be relayed to relevant vehicles and other devices through an alert via a satellite network 216. In such case, the vehicle 202 may convey the emergency or hazard alert, including relevant data, to satellite network 216 via satellite communication link 218. Such information or alert may be relayed then to vehicle 206 via satellite communication link 220 or other vehicles by the network 216, possibly using other satellite links. It should be understood that the satellite network 216 may provide more than a single satellite. Systems and methods of the present disclosure are not intended to be limited to any particular satellite system implementation. The remote server 201 may receive and/or send alert information via satellite link 217 as well. Thus, regardless of the specific communication technology or protocol, the remote server 201 can track and predict vehicle location and discriminate as to which vehicles should receive specific alerts.

The remote server 201 may also receive alerts from sources other than disabled or stopped vehicles. For example, emergency services, construction zones, and other sources may provide alerts for delivery to vehicles via the system 200. The remote server 201 may also have communication links to other systems for interchange of information. Such outside systems are represented by network 230 linked to remote server 201 by communication link 232. It should be understood that, unless otherwise indicated, communication links within the present disclosure may comprise internet connections based on any known protocol and/or dedicated connections based on any known protocol.

An alert, an alert signal, or an alert communication can take any number of forms. In one embodiment, an alert is simply a signal that a hazardous communication exists along with a location of the hazard. For example, a broadcast on a specific frequency may occur, or a digital signal delivered over any communicative coupling or communication link. However, increasing the information contained in an alert or alert signal, even with a small amount of data that requires little bandwidth or time to communicate, can greatly enhance the utility of an alert. For example, an alert may be indicated as corresponding to a stationary hazard (e.g., a stopped or disabled vehicle) or a mobile hazard (e.g., a slow moving vehicle or emergency services).

It is frequently the case that an electronic or digital alert concerning a road condition can be made available to a vehicle before sensors on-board the vehicle can detect the same condition. For example, the on-board sensors could not detect stalled vehicles or other obstacles that may be very near (in terms of distance or time) due to hills, curves, obstructing traffic, or other conditions. An electronic alert provided to the autonomous driving system enables the system to begin making driving or routing decisions much further ahead of time and decrease the likelihood of a collision, as well as decreasing traffic jams and choke points on the roadway.

The digital alerting system 102 provides alerts to a vehicle having self-driving capabilities (possibly having a system operationally similar to that of FIG. 1). The digital alerts may be considered as additional data streams or data points to be taken into consideration by the computer, processor, or system responsible for the ultimate self-driving implementation or decisions for the vehicle.

Although a digital alert with respect to a road condition may arrive before the condition can be sensed with any on-board sensors, in some cases a self-driving or autonomous system may nevertheless utilize an on-board sensor to verify the condition before any real-time driving input is altered based on the condition. For example, an old or stale alert may not result in the same driving decisions as a new alert. However, an alert may be the basis for reducing a detection threshold that would result in altered action by the autonomous driving system. For example, an alert for a stalled car may result in appropriate avoidance tactics for the self-driving system when the camera detects an obstacle, even if it is not clear yet to the camera or autonomous driving system that a detected item is actually a car (as opposed to a dark portion of the roadway, a bush, etc.).

Similarly, a digital alert may result in preliminary action being taken by the autonomous driving system with the presumption that on-board sensors may ultimately detect the obstacle or condition and need to take further action. For example, an alert for a disabled vehicle may result in the autonomous-driving system changing vehicle lanes or lowering speed until the disabled vehicle is passed even before a camera or lidar sensor can “see” the reported disabled vehicle.

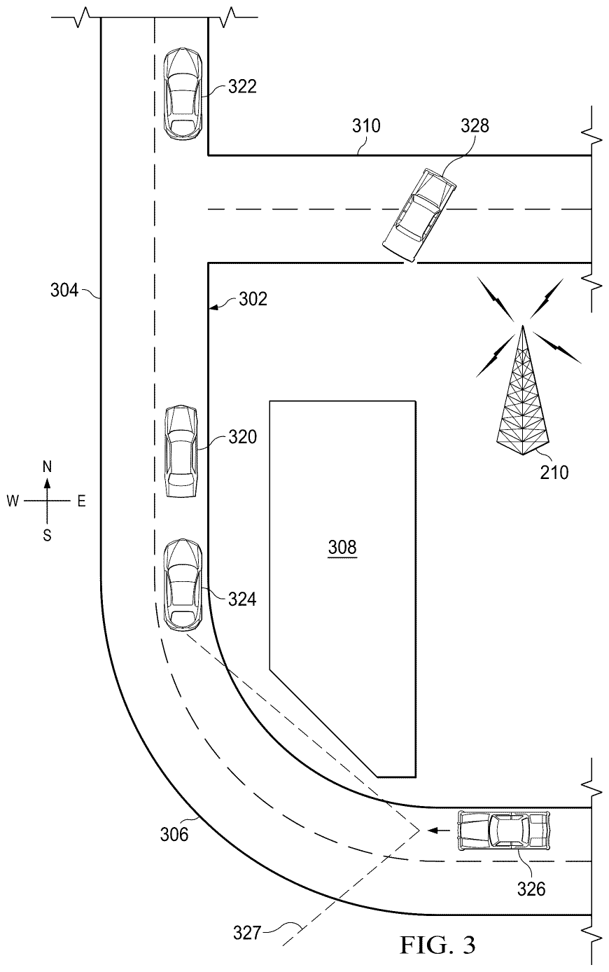

Referring now to FIG. 3 a roadway diagram showing various scenarios for operation of the systems of the present disclosure is shown. An example roadway 304 is shown with an approaching curve 306. The view around the curve 306 is at least partially obstructed by an obstacle 308. A side road 310 is also present.

A number of exemplary vehicles 320, 322, 324 are shown travelling northbound. A vehicle 326 is travelling westbound but is approaching the curve 306 in the road 304 veering north. Finally, a vehicle 328 is out of position and blocking both lanes of side road 310.

For purposes of the present illustration, the vehicle 326 is presumed to be a vehicle operating with some level of autonomy and equipped with a digital alerting system 102 according to the present disclosure. The vehicle 326 may be equipped with various sensors that may be able to detect the location, heading, and/or speed of vehicle 324 as soon as the vehicle 326 clears the obstacle 308 (e.g., as shown by example detection region 327). However, the presence of vehicle 324 can be made available to the vehicle 326 before it can be detected by onboard sensors utilizing systems and methods of the present disclosure.

While the location, heading, speed, etc. of the vehicle 324 could be made available to the vehicle 326 even if the vehicle 324 is not disabled, the on board sensors of vehicle 326 may be sufficient where traffic is flowing. However, where vehicle 324 is disabled or stopped, it may enhance safety or enable the autonomous driving system of vehicle 326 to operate more proactively, or take appropriate steps earlier, if an alert pertaining to the hazardous condition of vehicle 324 (i.e., being stopped on the roadway 304) is made available even before on board sensors can detect it. While the vehicle 324 may provide an alert to the alerting system (e.g., 200) directly, the alert does not necessarily come from the vehicle 324 itself (e.g., it could be provided by emergency services).

In a further example, the vehicle 320 may be stopped or disabled and the vehicle 324 is still approaching. Alerting the vehicle 326 of a stopped or disabled vehicle, even if it is ahead of intervening traffic (e.g., vehicle 324) may enable the vehicle 326 to begin slowing without having need to wait until its on board sensors determine that vehicle 324 is slowing. Moreover, it may enable vehicle 326 to avoid a collision even if vehicle 324 does not.

In a further example, vehicle 322 may be stopped, disabled, or otherwise blocking traffic. Such information may be useful by way of an alert to any of vehicles 320, 324, 326. If such vehicles are under autonomous control, such alert as input to the respective autonomous control systems may enable better driving decisions to be made by the system. One decision path for alerted vehicles may be to take an alternate path. One such alternate path or roadway may include side road 310. However, where side road 310 is blocked as shown, an alert indicating this and sent to any or all of vehicles 320, 324, 326 may prevent further delays and traffic jams by resulting in the vehicles 320, 324, 326 remaining on roadway 304 where they may be able to safely bypass stopped vehicle 322 eventually.

It should be understood that the present disclosure is not limited by the degree to which an autonomous driving system is equipped to take evasive action based on an alert. Suitable responses might include rerouting, stopping, changing lanes, or other responses. In some cases, the autonomous driving system may alert the driver and relinquish control while providing some indication as to the hazard ahead.

The remote server 201 (FIG. 2) may comprise a plurality of servers. In some cases, one or more servers are devoted to handling alerts for a specific geographic area. Redundancy (e.g., multiple remote servers) may be provided for a geographic area as well. The server 201 may be provided not only with vehicle location, direction, and speed information for multiple vehicles within its geographic area. The server 201 may be provided with map data as well. This enables the server 201 to discriminate between vehicles for receiving particular alerts in a more logical manner than mere location and/or heading/speed alone. For example, where the vehicle 328 is stopped or disabled and blocking roadway 310, it may not be necessary to alert vehicle 322 heading northbound and already past the intersection. However, an alert to any or all of vehicles 320, 324, 326 may be useful to prevent an associated autonomous driving system from turning onto roadway 310.

Sophisticated mapping data currently available can allow the server 201 to determine when a vehicle should receive an alert even where the roadway is wide (e.g., multiple lanes), divided, or complex (e.g., overpasses). Precise GPS data may be provided from vehicles travelling through an area monitored by the remote server 201 such that the remote server 201 can maximize the utility of alerts while minimizing nuisance alerts. For example, only one direction on a roadway may need to be alerted. In another example, only approaching vehicles are alerted (and not those that have passed the hazard). In some embodiments, the remote server may determine when and whether to alert an approaching vehicle based on the vehicle's predicted time to encounter the hazard. The time or location for receiving an alert can also be selected based on the road topology (e.g., before the last exit before the hazard). The location or time to provide an alert may also increase where traffic has begun to back up from a hazard or stoppage. Vehicles providing location and speed that are report to remote server 201 being stopped some distance behind a hazard may be inferred to represent the approximate location of traffic backup.

In a further example, an autonomous vehicle may be equipped to provide not only location, heading, and speed, but may also provide data relating to an intended route of the vehicle to the remote server 201. In such case, the remote server 201 may provide alerts to such vehicle only when they are on or likely to affect the intended route of the vehicle. For example, as shown in FIG. 3, vehicle 320 may not be alerted as to the presence and stoppage of vehicle 328 when it is known that the vehicle 320 is routed to continue northbound.

It should be understood that, in the context of the present disclosure, a remote server (such as remote server 201) may be considered remote because it is not necessarily in or dedicated to a specific vehicle. A remote server may track and provide alerts to many vehicles. In some cases, a network of remote servers exist (e.g., for redundancy or assigned to different geographic areas). The server 201 is a remote server in that it is not present on either of the vehicles 202, 206 nor even necessarily geographically limited by the locations of the vehicles 202, 206 or the roadway 204.

A remote server may comprise a dedicated server with one or more processors and associated memory and storage. In some embodiments one or more remote servers may be implemented as part of a cloud computing environment and be scalable by methods known to the art to increase or decrease capacity based on load.

In some embodiments, a disabled or stopped vehicle may display conspicuous or enhanced lighting that may more quickly and more easily catch the attention of motorists. This may be effected via the hazard lights, signal indicators, or other lights (e.g., as described with respect to vehicle 202 of FIG. 2). Operation of conspicuous lighting may be such as that known to the art and described in U.S. Pat. No. 9,481,331 B1 to Tucker et al. and titled ENHANCED COMMUNICATION SYSTEM FOR VEHICLE HAZARD LIGHTS.

The camera system (e.g., 110, FIG. 1) or another sensor of an autonomously driven vehicle may detect such enhanced or high conspicuity lighting for faster identification and specific location of a stopped or disabled vehicle (as opposed to a vehicle that is merely on the road with other traffic or travelling more slowly). In other embodiments a separate camera may be utilized with appropriate detection mechanisms and circuitry to feed into the autonomous driving system for further processing, similar to the wireless alerts of the present disclosure. Additionally, some alerts may indicate whether the hazard is a stopped vehicle displaying high conspicuity lighting. In this way an autonomous driving system may not only receive an alert pertaining to a disabled or stopped vehicle, but may be able to more quicky correlate the alert to a vehicle detected by local sensors on the autonomously driven vehicle.

In some instances, high conspicuity lighting may include a directional component (for example, left-to-right or vice versa). The directional component may be detected from the road way and provide further input or guidance to the autonomous driving system for maneuvering.

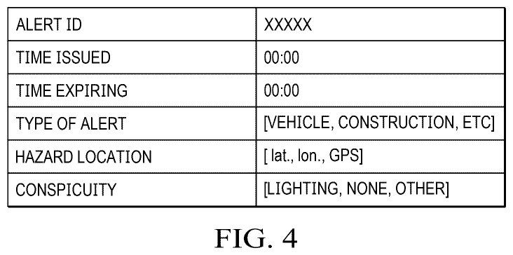

Referring now to FIG. 4, an example of a hazard alert data format that may be used by systems of the present disclosure is shown. It should be understood that the data may be presented in any manner and according to any protocol that is suitable. It should also be understood that other data fields or types may be present when needed. Further, not all alerts are required to have all of the fields shown nor necessarily to populate each field when sent.

In the example shown, a unique alert ID may be provided such that multiple alerts can be separately tracked and/or logged. While alerts may be delivered near instantaneously, a time stamp may be provided such that subsequent alerts can take precedence or for other reasons. Alerts may or may not expire automatically. In some cases, an expiration time is provided and the alert may expire at such time unless renewed, reissued, or superseded. In some cases, information may be provided as to the type of alert.

A location may be provided in order to provide specific location information to the autonomous driving system. The data format may be a GPS format, which could include elevation information to allow easier discrimination for overpasses, bridges, etc. However, in some embodiments, a simple latitude and longitude may be provided. As noted above, in some cases, a disabled or stopped vehicle may deploy high conspicuity lighting. In such case, the alert message may indicate this information for use by the autonomous driving system.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The terms “alert”, “message”, “communication”, “indication”, “signal” and similar may refer to the same or similar communication phenomena unless otherwise indicated explicitly or by context. Such communications are understood to be digital communications unless otherwise indicated explicitly or by context.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a microprocessor in a vehicle communicatively coupled to an autonomous driving system having at least some operational control over the vehicle; and
a radio receiver communicatively coupled to the microprocessor that receives an indication from a remote server that a condition exists at a roadway location predicted to be encountered by the vehicle within a predetermined timeframe;
wherein the microprocessor communicates the indication and its location to the autonomous driving system.

2. The system of claim 1, further comprising a global positioning system providing vehicle location and heading to the remote server for predicting whether the vehicle will be at the roadway location within the predetermined timeframe.

3. The system of claim 1, wherein the microprocessor predicts whether the vehicle will be at the roadway location within the predetermined timeframe.

4. The system of claim 1, wherein the condition comprises a stopped vehicle.

5. The system of claim 1, wherein the condition comprises a disabled vehicle.

6. The system of claim 1, wherein the condition comprises a vehicle deploying high conspicuity lighting.

7. The system of claim 1, wherein at least some operational control comprises less than full (level 5) control.

8. The system of claim 1, wherein at least some operational control comprises between level 0 and level 5 control.

9. The system of claim 1, wherein the microprocessor reports an event related to the vehicle along with at least vehicle location to the remote server via a radio transmitter.

10. The system of claim 9, wherein the event related to the vehicle comprises the vehicle being disabled or stopped on or within a predetermined distance of a roadway.

11. A system comprising
a remote server in communication with a plurality of vehicles utilizing wireless communication;
wherein each of the plurality of vehicles has an on board microprocessor communicatively coupled to an autonomous driving system having at least some operational control over the respective vehicle;
wherein each of the plurality of vehicles provides location and heading information pertaining to the respective vehicle to the remote server;
wherein the remote server receives an indication that a condition exists at a roadway location; and
wherein the remote server determines which of the microprocessors of the plurality of vehicles to communicate the condition to for communication to the respective autonomous driving system based in part on the location and heading information received from each of the plurality of vehicles.

12. The system of claim 11, wherein the remote server receives the indication that the condition exists at the roadway location from one of the plurality of vehicles.

13. The system of claim 12, wherein the condition is a non-moving vehicle on or near a roadway.

14. The system of claim 11, wherein each of the plurality of vehicles provides at least a global position system (GPS) location, a heading, and a speed to the remote server.

15. The system of claim 14, wherein the remote server determines which of the microprocessors of the plurality of vehicles to communicate the condition to by predicting which of the plurality of vehicles will be at the roadway location within the predetermined timeframe.

16. The system of claim 15, wherein the remote server utilizes mapping data to predict which of the plurality of vehicles will be at the roadway location within the predetermined timeframe by travelling on known roadways.

17. A system comprising:
a remote server that receives a notification of a safety event and a location associated therewith;
a plurality of microprocessors each one in communication with an autonomous driving system of a vehicle and with a global positioning system (GPS) associated with the vehicle; and
a data link between the remote server and the plurality of microprocessors;
wherein each of the microprocessors provides location information of the respective vehicle to the remote server via the data link; and
wherein the remote server provides an alert of the safety event and the location associated therewith to at least a subset of the plurality of microprocessors; and
wherein the subset of microprocessors each provides the alert and the location associated therewith to an input of the respective autonomous driving system.

18. The system of claim 17, wherein the subset of the plurality of vehicles comprise vehicles predicted by the remote server to be able to encounter the location associated with the safety event within a timeframe.

19. The system of claim 17, wherein the subset of the plurality of vehicles comprise vehicles predicted by the remote server to be able to encounter the location associated with the safety event within a timeframe using known roadways.

20. The system of claim 17, wherein:
the safety event is a stoppage on or near a roadway of one of the plurality of vehicles; and
the safety event is communicated by the one of the plurality of vehicles to the remote server via the data link.
